(19) United States
(12) Patent Application Publication
(10) Pub. No.: US 2006/0156851 A1
(43) Pub. Date: Jul. 20, 2006

(54) Mechanical serpentine device

(76) Inventors: Stephen C. Jacobsen, Salt Lake City, UT (US); David T. Markus, Salt Lake City, UT (US); David Marceau, Salt Lake City, UT (US); Shayne Zurn, Salt Lake City, UT (US)

Correspondence Address: THORPE NORTH & WESTERN, LLP., 8180 SOUTH 700 EAST, SUITE 200, SANDY, UT, 84070, US

(21) Appl. No.: 11/293,701

(22) Filed: Dec. 1, 2005

Related U.S. Application Data
(60) Provisional application No. 60/633,035, filed on Dec. 2, 2004.

(51) Int. Cl. B25J 18/00

(52) U.S. Cl. 74/490.01

(57) ABSTRACT

A serpentine device having a proximal end and a distal end comprising a series of discs arrayed in succession and on center along a common, neutral axis, wherein the discs comprise a first and second surface; and at least one flexible interconnect extending between and connecting each disc to any succeeding disc according to a pre-determined connection configuration, wherein the interconnects are indirectly connected to one another through the discs and configured to provide torsional and bending support to each of the discs connected thereto under an applied load, thus achieving a continuum of flexibility along an entire length of the serpentine device, as well as to facilitate the torquability of the serpentine device. The serpentine device may further comprise a bendable member and at least one transfer element configured to perform one or more transfer functions, namely the transfer of energy, work, fluid, electricity, light energy, sound energy, matter, etc. from one location to another location, and particularly from a source to one or more of the discs of the serpentine device. An actuation system is also featured, which is configured to selectively actuate the discs in a pre-determined direction in three-dimensional space.

This application claims priority to U.S. Provisional Patent Application No. 60/633,035, filed Dec. 2, 2005 in the U.S. Patent and Trademark Office, entitled, “Segmented Guidewire,” which application is incorporated by reference in its entirety herein.

### FIELD OF THE INVENTION

The present invention relates generally to serpentine devices employed for various purposes in various applications or industries, and more particularly to a mechanical serpentine device configured for improved efficiency, dynamic control and performance along its length. The present invention also relates generally to serpentine robots and guidewires, as variations of serpentine devices, wherein at least some of the concepts employed in constructing and operating a serpentine robot may apply to the same for guidewires.

### BACKGROUND OF THE INVENTION AND RELATED ART

Serpentine devices, such as serpentine robots or guidewires, are designed to exhibit snake-like movements with multiple degrees of freedom. They possess multiple joints that provide them with the ability to achieve multiple degrees of freedom in their movement, thus allowing them to navigate complex paths. These complex paths may be navigated about a surface or surfaces, about random structures (e.g., a pile of debris), across terrain, or in three-dimensional space.

Serpentine devices may be used for any number of purposes, such as in exploration, surveillance, reconnaissance, entertainment, medical/surgical, and other areas. Because of their high aspect ratio construction, they are able to negotiate inside tight spaces and to probe or inspect these from within, or venture where it may be otherwise dangerous for a human.

Serpentine robots or snakebots are a form of automated serpentine devices, wherein a plurality of actuators are configured to control the movements of the various components of the robot to achieve automated locomotion. Serpentine robots provide the ability to negotiate difficult terrain or structures for various purposes, such as to gather information or to conduct surveillance. Prior art serpentine robots are bulky, heavy, and consist of many components that require complex algorithms to control.

With respect to guidewires, these are a form of manually operated serpentine devices. Guidewires, as high aspect ratio-structures, have long been used in medical, industrial, and other fields for insertion into a lumen or conduit or other similar ducted structure for one or more purposes. For example, in the medical field an endoscope is a medical instrument for visualizing the interior of a patient's body. Endoscopes can be used for a variety of diagnostic and interventional procedures, including, colonoscopy, bronchoscopy, thoracoscopy, laparoscopy, and video endoscopy. The first step in a typical endoscopic procedure is placement of a guidewire into the appropriate system of the patient. When operatively disposed, the guidewire allows a variety of specialized tools, such as catheters, to be repeatedly positioned within the patient's system with ease, safety, and efficiency. One particular example is cardiac catheterization, which is a procedure accomplished by passing small tubes or catheters into the heart from arteries and veins in the groin or arm.

The use of guidewires in applications other than those for medical purposes include any applications in which it is desirable to inspect, repair, position an object such as tools within, or otherwise facilitate travel into and through a tube, pipe, or other similar conduit for one or more purposes. However, since guidewires are used most frequently in the medical field, these applications will be the focus of the discussion herein.

Catheters are used to perform various diagnostic and therapeutic procedures at selected sites within the body. However, intraluminal deployment of a catheter can often be difficult. The distance between the catheter entrance point and the target site is often considerable. In addition, the body has a highly branched vessel network that must be traveled to reach the target site. Moreover, the size of the lumen of the vessels leading to the target site are typically quite small. Therefore, the path which the catheter must follow are often narrow and tortuous. To assist in catheterization, navigation of a guidewire through the anatomy is often employed prior to insertion of the catheter. The deployment of a guidewire may be further assisted by radiographic imaging, which is conventionally done by introducing contrast media into the body lumen being traversed and viewing the guidewire in the body lumen using X-ray fluoroscopy or other comparable methods.

Catheter guidewires have been used for many years to “lead” or “guide” catheters to target locations in animal and human anatomy. This is typically done via a body lumen, for example such as traversing Luminal spaces defined by the vasculature to the target location. The typical conventional guidewire is from about 135 centimeters to 195 centimeters in length, and is made from two primary components—a stainless steel core wire, and a platinum alloy coil spring. The core wire is tapered on the distal end to increase its flexibility. The coil spring is typically soldered to the core wire at a point where the inside diameter of the coil spring matches the outside diameter of the core wire. Platinum is usually selected for the coil spring because it provides radiopacity for better fluoroscopic or other radiologic imaging during navigation of the guidewire in the body, and it is biocompatible. The coil spring also provides softness for the tip of the guidewire to reduce the likelihood of unwanted puncture of a luminal wall or the damaging of this and/or other anatomy.

The guidewire is equipped with a distal and proximate end. The proximal end, which remains outside the body, is manipulated to urge the guidewire along the vessel path and to control the tip of the guidewire positioned at the distal end. The tip is designed to be bent to a desired angle so as to deviate laterally a relatively short distance. By rotation of the proximal end of the guidewire, the tip can be made to deviate in a selected direction from a neutral or central axis of the guidewire about which it rotates. The catheter is advanced over the guidewire or the guidewire is inserted into a catheter so that the guidewire and the catheter cooperate to reach the target location. The guidewire can be advanced so that its distal end protrudes out the distal end of the catheter, and also pulled back in a proximal direction so as to be retracted into the catheter. The catheter enables introduction of contrast media at the location of the distal tip to enable the visualization of a Luminal space being traversed by the catheter and guidewire. The guidewire or catheter/guidewire combination are introduced into a luminal space such as a blood vessel and advanced therethrough until the guidewire tip reaches a desired luminal branch. The user then twists the proximal end of the guidewire so as to rotate and point the curved distal tip into the desired branch so that the device may be advanced further into the anatomy via the luminal branch. The catheter is advanced over the guidewire to follow, or track, the wire. This procedure is repeated as needed to guide the wire and overlying catheter to the desired target location. The catheter accordingly provides a means to introduce contrast media, and also provides additional support for the wire. Once the catheter has been advanced to the desired location, the guidewire may be withdrawn, depending upon the therapy to be performed. Oftentimes, such as in the case of balloon angioplasty, the guidewire is left in place during the procedure and can be used to exchange catheters.

As is known, a guidewire having a relatively low resistance to flexure yet relatively high torsional strength is most desirable. Stated differently, it is often desired that certain portions or all of a guidewire have lateral flexibility characteristics as well as pushability and torquability (torsional or rotational stiffness) characteristics. As the guidewire is advanced into the anatomy, internal frictional resistance resulting from the typically numerous turns and attendant surface contacts, decreases the ability to turn the guidewire and to advance the guidewire further within the luminal space. This, in turn, may lead to a more difficult and prolonged procedure, or, more seriously, failure to access the desired anatomy at the target location and thus a failed procedure.

A guidewire with high flexibility helps overcome the problems created by this internal resistance. However, if the guidewire does not also have good torque characteristics (torsional stiffness), the user will not be able to twist the proximal end in order to rotate the distal tip of the guidewire to guide its advance as required. Indeed, depending upon its use, a guidewire may be required to have adequate torsional strength over its length to permit steering of the distal tip portion into the correct vessel branches by axially rotating the proximal end. The guidewire, and especially the distal end portion, may be required to be sufficiently flexible so that it can conform to the acute curvature of the vessel network. Additionally, a guidewire with compression strength may be needed, wherein the compression strength is suitable for pushing the guidewire into the vessel network without collapsing.

### SUMMARY OF THE INVENTION

In light of the problems and deficiencies inherent in the prior art, the present invention seeks to overcome these by providing a serpentine device, wherein in one exemplary embodiment the serpentine device comprises a mechanical serpentine robot and/or, in another exemplary embodiment, the serpentine device comprises a segmented guidewire, each having improved operating characteristics.

In accordance with the invention as embodied and broadly described herein, the present invention features a serpentine device having a proximal end and a steerable distal end, wherein the serpentine device comprises a series of discs arrayed in succession and on center along a common, neutral axis, said discs comprising a first and second surface; and at least one flexible interconnect extending between and connecting each disc to any succeeding disc according to a pre-determined connection configuration to provide torsional and bending support for each of the discs under an applied load, wherein the flexible interconnects are configured to bias each of the connected discs to a pre-determined, static position, as well as to allow each of the interconnected discs to dynamically move through a pre-determined range of motions.

The flexible interconnects are designed to extend between and connect a disc to a succeeding disc in an indirect manner, meaning that the interconnects are independent structures, or are independent of one another, along the length of the serpentine device. The serpentine device may be formed to achieve a continuum of flexibility along an entire length of the serpentine device, or one or more stiff sections may be included in the serpentine device.

The serpentine device may further comprise a bendable member that extends coaxially about the neutral axis and that is operably coupled to the array of discs. The bendable member facilitates the axial alignment and positioning of each of the attached discs relative to one another when the serpentine device is subject to various axial compression and tension forces. Utilizing the bendable member in this configuration, the serpentine device is capable of being selectively fed and retracted into a ducted structure or other recess, crawl space, etc. The bendable member may be a unitary structure or a segmented structure.

The serpentine device further comprises one or more transfer elements configured to perform one or more transfer functions, namely the transfer of energy, work, fluid, electricity, light energy, sound energy, matter, etc. from one location to another location, and particularly from a source to one or more of the discs of the serpentine device. The transfer elements may be supported by the discs themselves, or on one or more surfaces of the interconnects connecting the discs, or both. In addition, the transfer elements may also be segmented to provide each disc or group of discs the ability to operate independent or semi-independent of any other disc or group of discs.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a partial perspective view of one exemplary embodiment of a serpentine device having an array of discs interconnected by two inverted band elements;

FIG. 2 illustrates a partial perspective view of one exemplary embodiment of a segment of serpentine device having interconnects in the form of coil spring elements;

FIG. 3-A illustrates a partial perspective view of one exemplary embodiment of a segment of serpentine device having interconnects in the form of linear band elements arranged in an inverted, doubled over connection configuration;

FIG. 3-B illustrates a partial perspective view of one exemplary embodiment of a segment of serpentine device having interconnects in the form of linear band elements arranged in a non-inverted connection configuration;

FIG. 3-C illustrates a partial perspective view of one exemplary embodiment of a segment of serpentine device having interconnects in the form of linear band elements arranged in an inverted, twisting connection configuration;

FIG. 3-D illustrates interconnects as attaching to the sidewalls of two adjacent discs;

FIG. 3-E illustrates interconnects commencing on the surface of a first disc, wrapping around the sidewalls of the first and second discs and attaching to a distal surface of an adjacent disc;

FIG. 4-A illustrates a partial perspective view of one exemplary embodiment of a segment of serpentine device having interconnects in the form of curved or nonlinear band elements arranged in an inverted, doubled over connection configuration;

FIG. 4-B illustrates a partial perspective view of one exemplary embodiment of a segment of serpentine device having interconnects in the form of curved or nonlinear band elements arranged in an inverted twisting connection configuration;

FIG. 5 illustrates a detailed segment of a serpentine device comprising a bendable member supported within a central aperture formed in each disc element, nonlinear band elements interconnecting the disc elements, and two tendon-type transfer elements extending between the disc elements for controlling the bending of the serpentine device segment, according to one exemplary embodiment of the present invention;

FIG. 6 illustrates a detailed view of a partial serpentine device segment comprising a plurality of transfer elements and various means or methods for supporting the transfer elements, each capable of operating with the array of discs interconnected by a nonlinear, inverted band element according to one exemplary embodiment of the present invention;

FIG. 7 illustrates a partial side view of a serpentine device having actuation means incorporated or operable therewith, according to one exemplary embodiment;

FIG. 8-A illustrates a partial cutaway side view of one exemplary embodiment of a disc and bendable member, wherein the bendable member comprises a non-circular cross-section;

FIG. 8-B illustrates a cross-sectional view of the bendable member and disc element configuration of FIG. 7-A, taken along line A-A;

FIG. 9 illustrates another exemplary embodiment of a serpentine device having a another exemplary type of bendable member supported or contained therein;

FIG. 10-A illustrates a partial perspective view of two discs in a serpentine device, each comprising two peripheral recesses formed in their respective sidewalls or edges, which recesses are radially spaced a pre-determined length from one another at the periphery of the discs and are configured to carry or support one or more transfer elements or interconnects therein;

FIG. 10-B illustrates a partial perspective view of two discs in a serpentine device, each comprising two peripheral extensions formed in their respective sidewalls or edges, which extensions are radially spaced a pre-determined length from one another at the periphery of the discs and are configured to carry or support one or more transfer elements or interconnects therein; and

FIG. 10-C illustrates a partial perspective view of two discs in a serpentine device, each comprising a plurality of radial apertures, which cavities are radially spaced a pre-determined length from one another at a position between the periphery of the discs and a neutral axis and are configured to carry or support one or more transfer elements or interconnects therein.

### DETAILED DESCRIPTION OF EXEMPLARY EMBODIMENTS

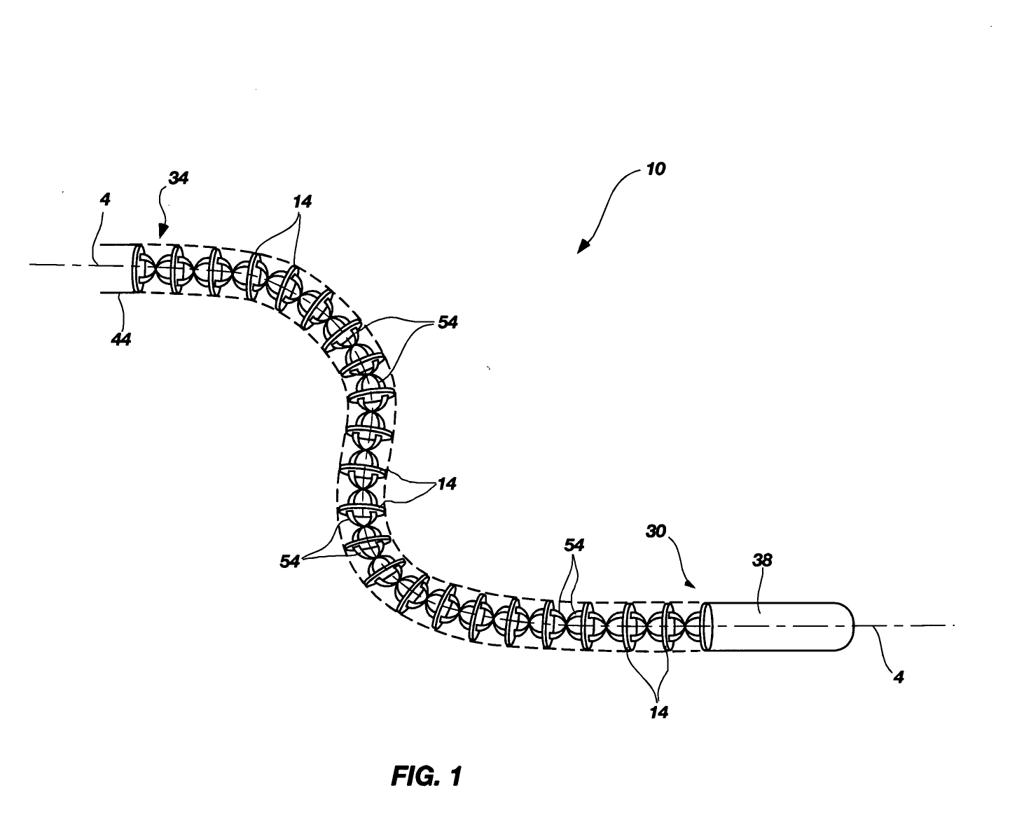

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art practice the invention, it should be understood that other embodiments may be realized and that various changes to the invention may be made without departing from the spirit and scope of the present invention. Thus, the following more detailed description of the embodiments of the present invention, as represented in FIGS. 1 through 10-C, is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

The present invention describes a segmented serpentine device comprised of an array of discs or disc elements connected by one or more interconnects, either stiff or preferably flexible, as well as various means for carrying and supporting one or more transfer elements. Also described is a method of operating the serpentine device of the present invention. The present invention serpentine device provides excellent torsional and bending properties due to the placement and configuration of the discs and their interrelationship with the array of disc elements, as well as an improved ability to transfer work, electricity, fluids, etc. to a specific disc, segment, or the entire length of the serpentine device as a result of the array of discs and their connected configuration.

Preliminarily, the term “serpentine device,” as used herein, shall be understood to mean any type of device exhibiting snake-like movements, whether under manual or automated control. For example, a serpentine device may comprise a serpentine robot having on-board power/actuation means configured to enable locomotion. In another example, the serpentine device may comprise a guidewire, wherein the guidewire is manually manipulated to negotiate a lumen.

The term “torquability,” as used herein, as well as similar terminology, shall be understood to function as the relative term used to describe the propensity of one or more segments of the serpentine device to rotate in response to an applied rotational force to the intended segments. The torquability is directly related to the torsional stiffness of the serpentine device as determined by the specific component characteristics present within the serpentine device, such as the spacing of the discs, the connection configuration of the interconnects, the material makeup of the interconnects, the number of interconnects between the discs, the properties of any bendable member present, and any other relevant serpentine device component characteristics.

The phrase “segmented serpentine device movement,” or “segmented movement,” as used herein, as well as similar phraseology, shall be understood to mean the specific dynamic properties exhibited by a particular segment of the serpentine device as determined by the specific component characteristics of that segment. A serpentine device may comprise multiple segments along its length, with each segment capable of exhibiting different dynamic characteristics, such as torsional stiffness or torquability, flexibility or bending, etc. A segment may comprise one disc or a plurality of discs.

The phrase “transfer element,” as used herein, as well as similar phraseology, shall be understood to mean any structural element configured or designed or capable of performing a designated transfer function, namely the transfer of energy, work, fluid, electricity, light energy, sound energy, matter, etc. from one location to another location. For example, in one aspect transfer elements may comprise rigid or flexible tendons configured to perform a mechanical function, such as to selectively transfer a bending force to any segment along the length of the serpentine device for steering, bending, and/or torquing the serpentine device. In another aspect, transfer elements may comprise electrical conductive lines, such as wires, plasma tubes, etc. configured to transfer electrical current or voltage to one or more discs along the length of the serpentine device, as received from a power source, for the purpose of powering various systems or devices, such as cameras, flashlights, tools, computer circuits, computer processors, etc. In still another aspect, transfer elements may comprise tubular structures configured to transfer fluids to one or more discs along the length of the serpentine device as received from a fluid source, wherein the supplied fluid may be used for one or more purposes, such as to effectuate local hydraulic or pneumatic actuation of a device or system supported by the disc, to supply the necessary fluid to a suitable tool requiring a fluid, to effectuate cooling of a system or device, or any other use as recognized by one skilled in the art. A fluid transfer element may also be a negative pressure transfer element configured to transfer fluid away from a local site. In still another aspect, a transfer element may further transmit light or energy used to provide illumination at a local site, or to provide laser energy or laser light for the carrying out of various tasks, such as ablation. A transfer element may comprise any structure or any type of structure extending along the length of the serpentine device, either in segments or as a single, continuous or uninterrupted length, and that is attached or inserted through one or more discs, preferably in an offset or radial manner from the neutral axis.

Referring now to FIG. 1, shown is a perspective view of one exemplary embodiment of a serpentine device 10. As shown, serpentine device 10 comprises a plurality of segments defined by the interspatial relationship of the plurality or series of discs 14. Specifically, serpentine device 10 comprises a series of discs 14 serially or successively arrayed on center along a neutral or common axis 4. The number and spacing of the discs 14 may be varied as desired or according to operational requirements. As will be explained in greater detail below, the spacing of the discs 14 greatly affects the torsional stiffness of the serpentine device 10, which torsional stiffness relates directly to the torquability of the serpentine device 10 during its use. In the embodiment shown, the discs 14 are rigid and comprise a flat, circular configuration with a first and second surface and a sidewall, much like a washer. The discs also comprise a specific cross-sectional area. The cross-sectional area of the discs 14 should be sufficiently small for the distal end portion 30 to navigate easily through the narrowest duct within the duct network. However, it is noted herein that the discs 14 may comprise any geometrical configuration, as well as any cross-sectional area, and may be comprised of a rigid, semi-rigid, or pliable material, each depending upon the designated application in which the serpentine device is intended for use.

The particular intended application will dictate the allowable material composition of the discs 14. For instance, if the serpentine device is intended for use within a fluid flow channel or pipe made of metal or plastic, the discs 14 may be made of any suitable material, such as steel, copper, titanium, plastics, or others. Environmental considerations will be taken into account in determining the proper material makeup of the serpentine device.

In another exemplary embodiment the structure may be configured as a guidewire for use in interventional medicine, such as for various endoscopic or coronary procedures. In such case, it is important that the discs be made of a biocompatible material, such as stainless steel or a NiTi alloy. In addition, the discs can comprise monolithic micromachined discs or structural members or actuators.

In addition, it is specifically noted that the discs 14 may comprise any shape or geometric configuration. For instance, the discs 14 may be circular, square, honeycomb, etc. The discs may further comprise planar or non-planar surfaces, or any combination of these. Generally, the discs 14 will be circular and planar.

The serpentine device 10 further comprises a distal end 30 and a proximal end 34.

The distal end 30 is defined as the leading portion or end of the serpentine device 10. In one aspect, the distal end 30 may be caused to negotiate passively through a duct. In another aspect, the distal end 30 may be selectively steerable. In the selectively steerable embodiment, the distal end 30 is selectively bent, thus allowing the distal end to be 30 steered. The steering of the distal end 30 may be achieved by way of a steering control device commonly known in the art, such as a joystick, or any other known steering control means.

The proximal end 34 is defined herein as the trailing end opposite that of the distal end 30. In the case of a serpentine device, the proximal end functions in a similar manner as other segments of the device. In the case of a guidewire, the proximal end 34 is typically that end of the guidewire that is manipulated or operably coupled to various devices designed to control the dynamic characteristics of the guidewire to cause the guidewire to traverse or negotiate through the ducted structure, such as an artery.

The serpentine device may further comprise a tip 38 disposed or located about its distal end 30. The tip 38 comprises any geometric configuration and material commonly known and used in the art. In the case of a guidewire, it is recommended that the tip 38 comprise a blunt body to reduce the risk that the tip will puncture or tear a vessel or other anatomical wall. The tip 38 is securely coupled to the distal end 30 of the guidewire 10 using any known means in the art. For example, the tip 38 may be cemented, thermally fused, crimped, fastened with clamps, screwed, or otherwise attached to the distal end 30 of the guidewire 10.

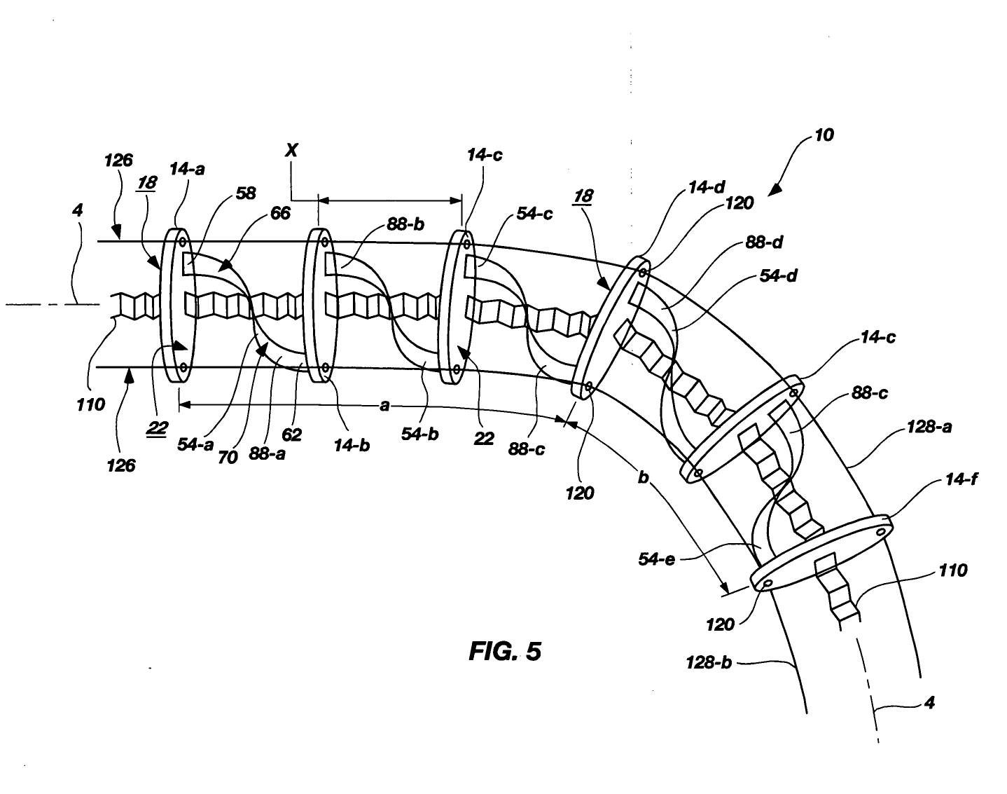

The discs 14 are spaced apart along the neutral axis 4 by a distance which creates a gap between adjacent or successive discs 14 (see gap having a distance x in FIG. 5). Located within these gaps and extending between discs 14 are interconnects 54. The interconnects 54 comprise first and second ends that are fixed to the discs. Essentially, the interconnects 54 are configured to operably connect each of the discs 14 together. In some embodiments, each interconnect 54 may be configured to bias each of the discs to a pre-determined static position, while also allowing the attached discs to dynamically move through a pre-determined range of motion. Therefore, each disc along the length of the serpentine device has a pre-determined orientation with respect to each succeeding disc, wherein the discs are biased into this orientation by the interconnects. Because of their configuration and makeup, it is intended that the interconnects facilitate or accommodate some degree of dynamic movement by the discs that enable the serpentine device to be steered or to conform to the contours of a surface or structure. The interconnects, because of their composition, also facilitate or accommodate the torquability of the guidewire, wherein one or more of the discs or segments along the guidewire may be selectively torqued and/or bent.

In several exemplary embodiments, interconnects 54 are spring elements of one or more types and that are arranged in one or more connection configurations between discs 14. The interconnects may be constructed of any suitably flexible material. For example, the interconnects may be formed of rubber, plastic, etc. In other embodiments, the interconnects may be formed of a more rigid material, such as stainless steel or brass. In still other embodiments, the interconnects may be formed of a shape memory material as is commonly known in the art. In still other embodiments, the interconnects may be formed of piezoelectric material to effectuate one or more designated piezoelectric functions, such as creating a localized piezoelectric effect for one or more purposes, such as actuation.

For each disc along the length of the serpentine device 10, there is at least one interconnect 54 extending between it and any succeeding disc(s), whether forward or aft or both of the disc. In the embodiment shown in FIG. 1, serpentine device 10 is shown as comprising at least one (shown as two) interconnects 54 extending between each of a plurality of discs 14.

As stated, in various exemplary embodiments interconnects 54 are independent and indirectly connected spring elements that function to connect each of the discs 14 to any succeeding disc(s) allowing them, and the serpentine device, to exhibit specific torsional and bending or flexibility properties. In general, interconnects 54 comprise a stiffness constant or stiffness ratio resulting from their material composition that determines the resistance each specific interconnect will demonstrate in response to an applied rotational or torque force, as well as its ability to flex. Contributing to the overall torsional stiffness and flexibility of the serpentine device 10 is the number of interconnects 54 used to interconnect the discs 14, their relative size and geometry, the position and orientation in which they are attached to the discs 14, as well as the connection configuration of each of the interconnects 54. Also contributing to the overall torsional stiffness and flexibility of the guidewire 10 is the spacing or gap distance between discs 14. The serpentine device 10 in FIG. 1 comprises two interconnects 54 in the form of band elements that extend between and attach to the corresponding surfaces of the discs 14. The interconnects 54, or band elements, are shown having an inverted connection configuration, wherein the first and second surfaces of the band elements are inverted and twist at least once within the gap existing between their attached discs. The connection configuration shown in FIG. 1 is representative of only one exemplary connection configuration. Indeed, several additional connection configurations are available, some of which are described in greater detail below.

In those embodiments where interconnects 54 are or function as spring elements, discs 14 are allowed to move in multiple, but limited, degrees of freedom along the -x-, -y-, and -z- axes. In addition, because of the indirect connection relationship between the interconnects 54, selective movement of each disc, or selective movement of any number of discs (i.e., a segment), within three-dimensional space may be specifically controlled using a suitable controller operating via a corresponding computer program as is known in the art. Movement of the discs or a segment of discs is achieved without buckling or kinking of the serpentine device as a result of the biased nature existing between each disc as imposed by the interconnects. Therefore, if negotiating a turn in a ducted network, the interconnects 54 function to allow the discs 14 to flex or bend and rotate as needed, while continuously maintaining a proper position with respect to one another.

Because the interconnects 54 are indirectly connected to one another through the discs 14, thus allowing each of the discs 14 to be semi-independent from one another, the serpentine device 10 may comprise multiple segments, each having different torsional stiffness and flexure or bending properties. This may be advantageous in situations where a large torsional stiffness is needed at the proximal end to negotiate a more flexible tip, or where precision control of a certain segment of the serpentine device along a certain span of a ducted structure or network is needed. Unlike conventional serpentine devices where the segments are all strictly interconnected and dependent upon each other, the unique interconnects described herein, and their connection configuration, allow the serpentine device of the present invention to comprise independently or semi-independently operable sections, thus allowing the serpentine device to truly be segmented. Indeed, the serpentine device of the present invention is segmented not only in structure, but in operating characteristics or properties as well.

In addition, the indirect connection of the interconnects 54 through the discs 14 functions to provide a continuum of flexibility along an entire or partial length of the serpentine device 10, while simultaneously facilitating the torquability of serpentine device 10.

Interconnects 54 are attached to discs 14 using any attachment or fastening means known in the art. In addition, in some embodiments, interconnects 54 may be removably connected to discs 14, or rather discs 14 may be removably interconnected, thus allowing a selective number of the discs 14 to be removed and a length of the serpentine device 10 selectively altered.

Interconnects 54 may attach or couple to the surfaces of adjacent discs 14, or they may attach to the sidewalls of adjacent discs 14, or they may wrap around the sidewall and attach to a distal surface of adjacent discs. Interconnects 54 and discs 14 may comprise any known material composition suitable for the intended application of the serpentine device formed by the interconnects and the discs. In one aspect, interconnects 54 and discs 14 may be made of a biocompatible material suitable for insertion into a patient's body. In other aspects, interconnects 54 and discs 14 may be made of any metal, plastic, or combination of these. In another aspect, interconnects 54 may be formed of a shape memory alloy as one exemplary means of achieving bending and/or rotation actuation of the discs 14, and therefore locomotion. The term Shape Memory Alloys (SMA) is applied to that group of metallic materials that demonstrate the ability to return to some previously defined shape or size when subjected to the appropriate thermal procedure. Generally, these materials can be plastically deformed at some relatively low temperature, and upon exposure to some higher temperature will return to their shape prior to the deformation.

In some embodiments, the serpentine device 10 may also be selectively adjustable. The indirectly connected nature of the interconnects 54 allows the serpentine device to comprise any length or any number of segments, as well as to allow segments of different properties to be interchanged. Depending upon the means used for connecting or attaching the interconnects 54 to the discs 14, the serpentine device length may be selectively lengthened and/or segments added simply by attaching additional interconnects and discs to an existing series. The serpentine device length may also be selectively shortened and/or segments removed by detaching one or more discs and their corresponding interconnects. Thus, a serpentine device may be quickly assembled to comprise the necessary operational characteristics or properties needed for a particular application.

FIG. 1 further illustrates an optional supportive sleeve or sheath 44 configured to encapsulate or enclose the array of interconnected discs 14. Sheath 44 may comprise any of those commonly known in the art for use with serpentine devices, and is preferably a flexible sheath.

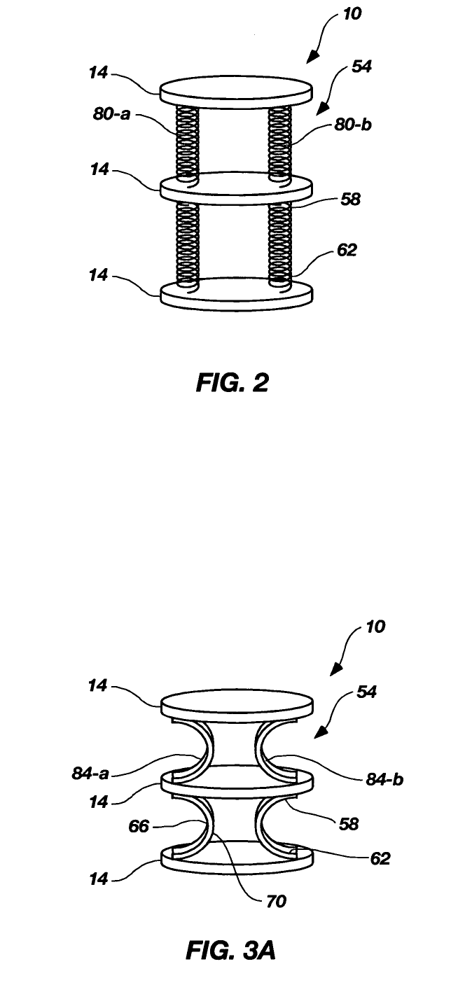

It is contemplated herein that interconnects 54 may comprise several different types, as well as several different connection configurations for connecting each of the discs together in series along the neutral axis to form a serpentine device. FIG. 2 illustrates a partial perspective view of one exemplary embodiment a segment of serpentine device 10, wherein interconnects 54 are comprised of compression or coil springs 80 having a pre-determined spring constant or stiffness ratio configured to achieve pre-determined torsional and bending properties between each interconnected disc and along the length of the serpentine device. The number of springs and their attachment position or location on the surfaces of the discs may vary. In the embodiment shown, four springs, identified as springs 80-a-80-d are equilaterally spaced about the surfaces of the discs. The number and placement of the springs will largely depend upon the size and shape of the discs, as well as the bending and torsional properties desired in the serpentine device. In operation, as the serpentine device is being fed into a ducted structure or network, or as the serpentine device is caused to negotiate about a structure or complex surface or terrain, the discs of the serpentine device are caused to bend and torque in an amount directly proportional to the properties present in the spring elements and as they are in cooperation with one another.

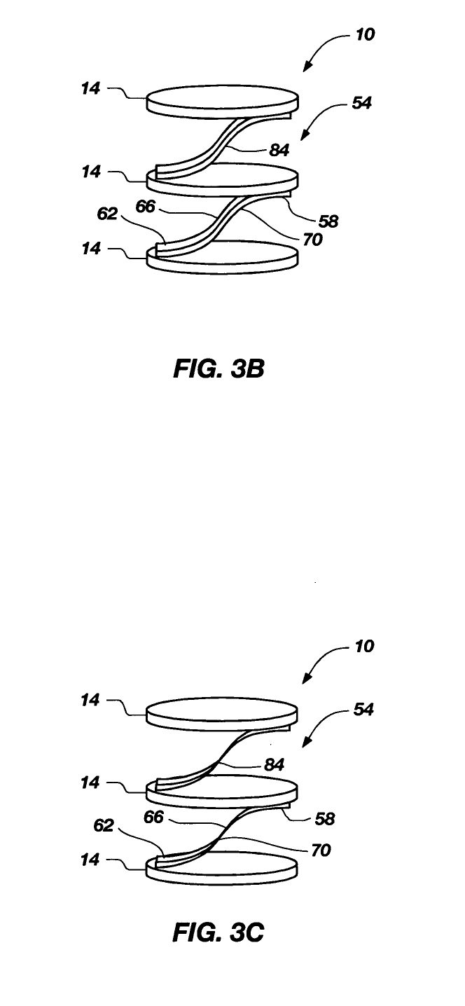

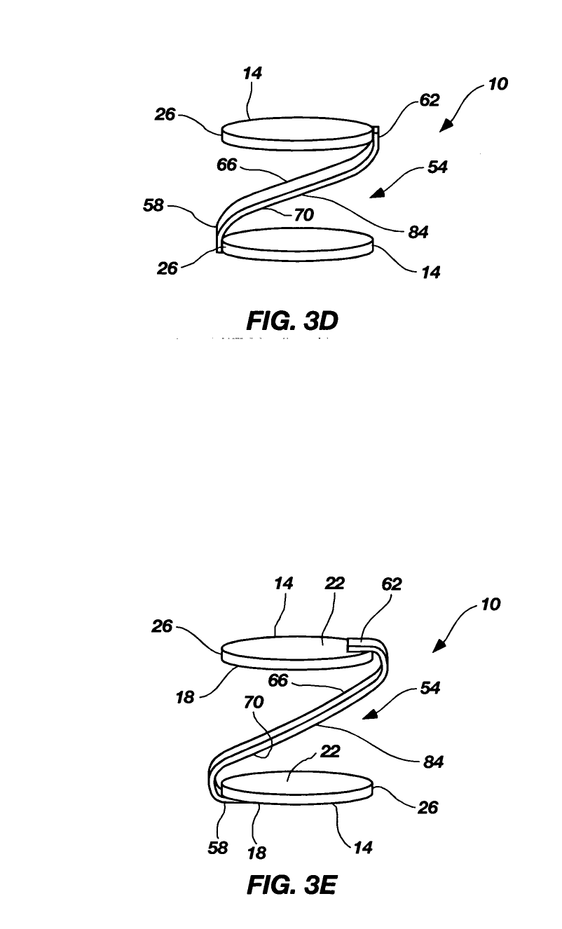

FIGS. 3-A-3-C illustrate partial perspective views of various alternative exemplary embodiments of a segment of serpentine device, wherein interconnects 54 are comprised of band elements 84 having a linear shape configuration, meaning that each surface of the interconnects is formed of linear line segments intersecting each other on an angle to form an area. In one aspect, the band elements are comprised of a material exhibiting sufficient bending and torsional properties. Preferably, the band elements are formed of a suitable material exhibiting constant strain properties throughout when subjected to a bending or torsional load.

Specifically, FIG. 3-A illustrates two band elements 84-A and 84-B extending between each of discs 14 and connected so that their ends are positioned or oriented to extend radially outward from the neutral axis. As shown, band elements 84-A and 84-B are diametrically opposed to one another and comprise an inverted connection configuration. An inverted connection configuration is defined herein as that configuration at which any vector extending in a perpendicular direction out from any point on any surface of a band element is at least 90° from any other perpendicular extending vector along the same surface. Stated differently, each surface of the band elements 80 may be thought of as comprising an infinite number of normal or perpendicular vectors extending from an infinite number of corresponding points on each of their surfaces. At any time the surface of a band element is arranged in a connection configuration so that any of these vectors is at least 90° from one another, it may be said that the surface is inverted. In the embodiment shown in FIG. 3-A, band elements 84 are present in a doubled over connection configuration, such that the ends of the linear band elements are positioned in substantially parallel and offsetting planes and the vectors along surface 66 at the ends 58 and 62 are inverted to be substantially 180° from one another. In this configuration, the serpentine device, and specifically the band elements, tend to be less resistant to torque or torsional forces because of the decrease in longitudinal strain along the length of the band element when subjected to a torsional load. In addition, the band elements in this configuration tend to exhibit relatively good bending characteristics as compared to those embodiments having discs interconnected using other connection configurations. While not shown, the band elements may be any suitable size and may be positioned at different locations along the surface of the discs, such as with four band elements placed an equidistance apart from one another.

FIG. 3-B illustrates a single band element 84 extending between each of discs 14 and connected so that its ends are also positioned or oriented to extend radially outward from the neutral axis. As shown, band element 84 is arranged so that its surfaces are not inverted, but are instead arranged in a constant facing orientation. In other words, the surfaces of band element 84 each comprise an infinite number of vectors extending perpendicular therefrom, wherein each of the vectors on a given surface, and thus the corresponding surface points, are all at angles from one another less than 90°. The serpentine device may comprise additional band elements arranged in a similar manner to interconnect the discs 14 to one another. Using this type of connection configuration, as compared with other connection configurations utilizing a band element of equivalent size and material makeup, the serpentine device comprises relatively good flexure or bending properties, as well as a relatively high resistance to torsional forces due to the longitudinal strain within the band element as it is forced to twist while attached to the discs.

FIG. 3-C illustrates a single band element 84 extending between each of discs 14 and connected so that its ends are also oriented to extend radially outward from the neutral axis. In this embodiment, band element 84 is similar to the band element in FIG. 3-A in that it is also arranged in an inverted connection configuration. However, instead of being arranged in a doubled over configuration, the surfaces of element 84 are arranged in a twisted or twisting configuration as the band element extends from the surface of one disc to the surface of a succeeding or adjacent disc. Of course, additional band elements may be used to interconnect two discs as in other embodiments.

FIG. 3-D illustrates interconnects 54 as attaching to the sidewalls of discs 14. Specifically, first end 58 of interconnect 54 attaches to sidewall 26 of one disc, extends to an adjacent disc 14, with second end 62 attaching to the sidewall 26 of the adjacent disc 14 as shown.

FIG. 3-E illustrates interconnects 54 as wrapping around sidewalls 26 of discs 14 and attaching to a distal surface of an adjacent disc 14. Specifically, first end 58 of band element 84 is shown attached to first surface 18 of disc 14. Band element 84 wraps around the sidewall of disc 14 and extends to an adjacent disc 14, wraps around its sidewall 26, with second end 62 attaching to the second surface 22 of the adjacent disc.

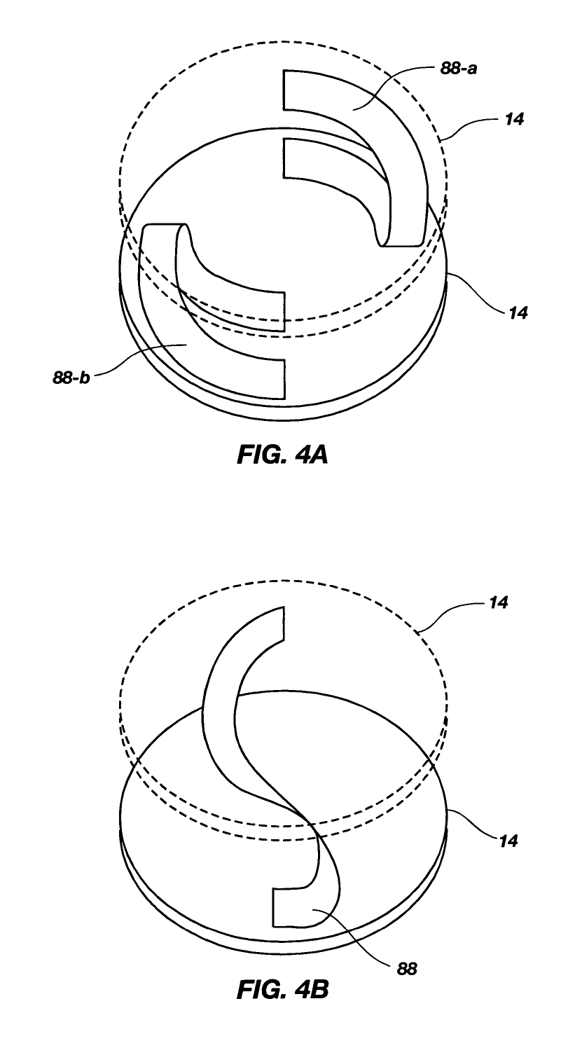

FIGS. 4-A and 4-B illustrate other exemplary embodiments of a serpentine device utilizing interconnects 54 in the form of band elements 88. The band elements 88 illustrated in FIGS. 4-A and 4-B are similar to those band elements 84 shown in FIGS. 3-A-3-C, only band elements 88 comprise a nonlinear or curved shape. Specifically, band elements 88 are shown comprising a semi-circular shape. In FIG. 4-A, two band elements 88-a and 88-b are utilized to interconnect discs 14 by doubling over each of band elements 88-a and 88-b, which band elements 88 are similar to and function in a similar manner as the band elements 84 that are shown doubled over in FIG. 3-A. Providing a nonlinear shape to band elements 88 allows them to better function with the discs 14, which preferably comprise a similar same shape as the band elements 88. As can be seen, the band elements 88 are coaxial with the discs 14 such that the outer radius of band elements 88 complements the perimeter of discs 14. In addition, the curved nature of the band elements 88 makes more efficient use of the circular surface of the discs by complementing their shape. For example, in those embodiments utilizing a bendable member, the discs 14 will be provided a greater degree of freedom to flex about the bendable member without obstruction from the band elements 88, as compared to utilizing linear band elements on discs of the same size and shape.

FIG. 4-B illustrates an embodiment having a nonlinear band element 88 arranged in an inverted manner, similar to the linear band element 84 illustrated in FIG. 3-C.

One recognized advantage of utilizing an interconnect in the form of a band element arranged in an inverted twisting or non-inverted configuration is its ability to support one or more various structural elements, such as a segmented transfer element as defined herein, along its surfaces. By doing so, transmission of various items, such as electricity, fluids, mechanical work, etc. between discs and from the proximal end of the serpentine device to one or more interim discs, or to the distal end of the serpentine device, is done in a segmented manner that provides many advantages over prior related serpentine devices. Thus, each disc arrayed along the neutral axis is capable of being utilized as an intelligent performance center.

In another exemplary embodiment, the interconnects, such as those illustrated in FIG. 4-B, may be comprised of a type of Kapton material manufactured by E. I. du Pont de Nemours and Company, which comprises one or more electrical conductors integrally formed therein. As known, Kapton is a polyimide material, which is basically a polymer material with a circuit structure or pattern integrally supported therein that function as a conductor of electrical signals. There are various types of Kapton material, each of which are contemplated for use herein. Each end of the Kapton material may be electrically coupled to one or more electrodes, electroplate pads, or any other electrical connector supported within or on the disc components. In this example, electricity from an electrical power source may be transferred along the length of the serpentine device via the interconnects. Such electrical conduits may either replace or complement additional and separate electrical wires or conduits extending through disc elements in a manner coaxial and offset from the neutral axis. In addition, since the transfer elements may be segmented, the ability for each disc to be able to function as a different performance center than the preceding or succeeding disc is more easily accomplished. Indeed, any number of discs, or segment of discs, may be utilized to perform a function different than other discs as the transfer elements used to supply the necessary operating characteristics to the discs may be segmented.

In another example, the band element interconnects themselves may comprise a material makeup capable of conducting electricity, or carrying one or more transfer elements thereon.

By manipulating the size, shape, spacing, and orientation of the discs, the torsional stiffness of the serpentine device relative to its flexibility or bending stiffness may be selectively altered. In addition, by manipulating the size, shape, number, and composition of the interconnects connecting the series of discs, the torsional stiffness of the serpentine device relative to its flexibility or bending stiffness may also be selectively altered. Therefore, a serpentine device having a high degree of flexibility and a low degree of torsional stiffness will likely comprise a relatively lower number of discs that function to make up the serpentine device than that for a serpentine device having a low flexibility and/or a high degree of torsional stiffness. Likewise, a serpentine device with a high degree of flexibility and a low degree of torsional stiffness will likely comprise interconnect elements having relatively lower spring constants and greater flexibility than the interconnects for a serpentine device having a low degree of flexibility and a high degree of torsional stiffness.

FIG. 5 illustrates a partial view of another exemplary embodiment of a segmented serpentine device 10. In this embodiment, serpentine device 10 comprises multiple segments, two of which are shown and labeled as segment a and segment b. Segment a comprises discs 14-a-14-d, while segment b comprises discs 14-e-14-f. As indicated above, segment a may comprise different torsional stiffness and bending or flexure properties than segment b by altering or modifying one or all of the spacing between discs 14, the type and number of interconnects 54 used, the connection configuration of the interconnects 54, etc. Of course, serpentine device 10 may comprise uniform operational characteristics or properties (e.g., torsional stiffness and bending or flex) along its length.

FIG. 5 also shows serpentine device 10 as featuring circular discs 14 having a first surface 18 and a second surface 22, with a specific cross-sectional area or diameter that substantially determines the size or width of the serpentine device 10. The size of the serially attached discs 14, as well as the interconnects 54 connecting them, may comprise different sizes or may vary in size from segment to segment or from disc to disc along the length of the serpentine device 10.

Also as shown in FIG. 5, serpentine device 10 features interconnects 54 comprised of band elements 88 of a rectangular linear shape and having a first end 58, a second end 62, a first surface 66, and a second surface 70. First end 58 of interconnect 54-a attaches to disc 14-a so that surface 22 of disc 14-a and surface 70 of interconnect 54-a are adjacent and juxtaposed to one another. Moreover, first end 58 of interconnect 54-a is attached in a radially outward extending manner from the neutral axis 4 using any fastening means known in the art. From surface 18 of disc 14-a, interconnect 54-a extends outward until second end 62 of interconnect 54-a contacts and is attached to surface 18 of disc 14-b. However, as it extends from surface 22, interconnect 54-a, or rather its surfaces 66 and 70, are inverted so that the surface of the interconnect 54-a adjacent and juxtaposed to the surface 22 of disc 14-a is the same as the surface adjacent and juxtaposed to the surface 18 of disc 14-b. In this embodiment, interconnects 54 twist once before attaching to an adjacent disc 14. This process is repeated with indirectly connected interconnects used to attach each of discs 14-a-14-f.

FIG. 5 also illustrates serpentine device 10 as comprising a bendable member 110 in the form of a helical or coiled wire extending through apertures formed within discs 14 that are coaxial with the neutral axis 4. Therefore, bendable member 110 is aligned to be coaxial with the neutral axis 4. Bendable member 110 functions to axial align and position each of the discs 14 relative to one another when the serpentine device is subject to one or more axial compression or tension forces, as well as various bending forces, during its operation. The bendable member provides additional compression and tensile strength to the serpentine device, thus allowing the serpentine device to be selectively fed into and retracted from a ducted or other small space environment.

The bendable member is made to extend between the discs. The bendable member may be comprised of a coiled compression spring extending up the center of the array of discs (like a spinal cord) or it may be comprised of a ball joint configuration. In addition, as will be explained in further detail below, the bendable member may comprise a non-circular cross section configured to provide advanced or improved movement or displacement of the serpentine device, and particularly to better accommodate the discs during actuation of the serpentine device, namely the bending and rotation of the discs. In some exemplary embodiments, the bendable member may be segmented, along with any transfer elements and interconnects utilized by the serpentine device, to allow various disc segments to be selectively and removably coupled together. In this embodiment, the serpentine device may be selectively lengthened and shortened.

Formed in each of discs 14 are one or more radially positioned or situated apertures 120, which may be any type of orifice, aperture, crevice, fissure, cavity, etc., formed in, around, or through the surfaces 18 and 22 of discs 14. Radial apertures 120 are characterized by their offset position or location and their divergence from the central or neutral axis 4. Radial apertures 120 function to receive one or more transfer elements 126 configured to perform a specific function, either locally at a particular disc, at a segment of discs, or along the entire length of the serpentine device. The types of transfer elements operable with radial apertures 120 and discs 14 are numerous, as discussed above. For example, a transfer element may comprise rigid or flexible tendons configured to perform a mechanical function, such as to selectively transfer a bending force to any segment along the length of the serpentine device for steering, bending, and/or torquing the serpentine device. In another aspect, transfer elements may comprise electrical conductive lines, such as wires or plasma tubes, configured to transfer electrical current or voltage to one or more discs along the length of the serpentine device for one or more purposes. In still another aspect, transfer elements may comprise tubular structures configured to transfer fluids to one or more discs and a local site along the length of the serpentine device as received from a fluid source, wherein the supplied fluid may be used for one or more purposes, such as to effectuate local hydraulic or pneumatic actuation of a device or system supported by the disc, to supply the necessary fluid to a suitable tool requiring a fluid, to effectuate cooling of a system or device, or any other use as recognized by one skilled in the art. A fluid transfer element may also be a negative pressure transfer element configured to transfer fluid away from a local site.

FIG. 5 further illustrates serpentine device 10 as comprising complementary axial mechanical transfer elements 126 in the form of tendons 128-a and 128-b. Tendons 128 may be any structure(s) known in the art capable of transferring a bending force to any portion or segment of the serpentine device 10 along its length. Tendons 128-a and 128-b particularly function to selectively steer or negotiate the distal end and the tip (each not shown, but see FIG. 1) through a ducted network as commonly known in the art. Each tendon is inserted through and supported by a radial aperture 120 in the form of an aperture formed through each of the discs 14, thus allowing the tendons 128 to be inserted into and pass through each disc. Selectively manipulating one or both of the tendons 128 has the effect of bending a pre-determined length of the serpentine device 10, such as steering the tip (not shown). Tendons 128 may also be configured to perform various other mechanical functions, as desired.

Finally, FIG. 5 illustrates discs 14 spaced apart a distance x. In one exemplary embodiment, discs 14 may be spaced an equidistance from one another along the length of the serpentine device 10, thus achieving uniform stiffness along the length of the serpentine device, assuming the interconnects are the same. In another exemplary embodiment, discs 14 may be spaced at varying distances from one another, thus achieving varying stiffness ratios along the serpentine device, again assuming the interconnects are the same. In still another exemplary embodiment, various segments along the length of the serpentine device, each comprising a pre-determined number of discs 14, may also comprise equidistantly spaced discs 14 or discs spaced at varying distances.

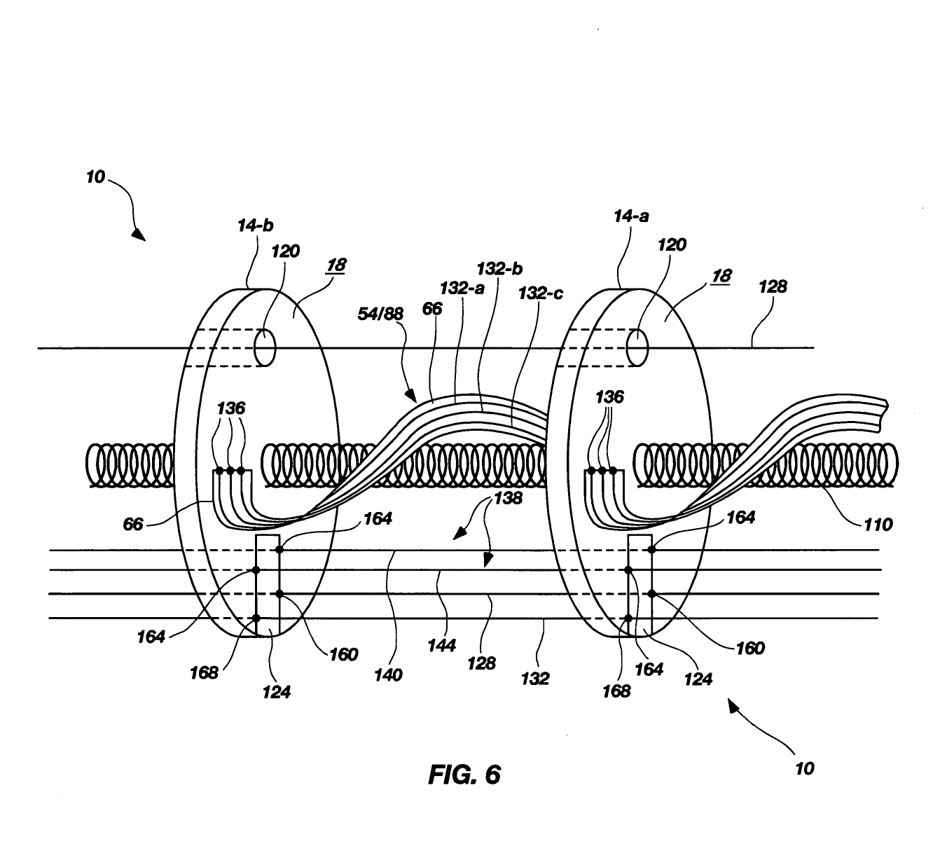

Referring now to FIG. 6, shown is a partial segment of an exemplary serpentine device 10. Discs 14-a and 14-b are spaced apart from one another a pre-determined distance along bendable member 110, which may be continuous or segmented, and which functions to provide compression and tension support to serpentine device 10, as discussed above. Formed in each surface 18 of each of discs 14-a and 14-b are radial apertures 120. Radial apertures function or are configured to carry one or more transfer elements as discussed herein, such as one or more electrical conductive lines, one or more tendons, etc. In the embodiment shown, radial apertures 120 comprise a through aperture configured to carry tendon 128 as commonly known in the art. Discs 14-a and 14-b may further comprise additional radial apertures 120 along surfaces 18 for carrying similar or different transfer elements.

FIG. 6 further illustrates interconnects 54 in the form of curved bands 88 having a plurality of segmented transfer elements carried on at least one surface 66 thereon, which surface is shown inverting with second surface 70 (not shown). As shown, transfer elements are comprised of electrical conductive lines 132 that function to transfer or carry electricity and/or various electrical signals/current between the discs 14-a and 14-b of the serpentine device. In this configuration, disc 14-a is capable of utilizing the electrical signals transferred from a power source through transfer elements 54 to perform a different operation or function than disc 14-b, if so desired, because whatever utility device, processing system, etc. residing may be electrically connected to the transfer element locally at the disc site.

Conductive lines 132 are electrically coupled to each disc 14-a and 14-b via electrical connectors 136 formed through discs 14. From these connectors 136, various utility, processing, and other devices or systems may be operably connected. In one exemplary embodiment, interconnects 54 may comprise a type of Kapton material, having various conductive lines formed therein as commonly known in the art. Independent segments of Kapton are configured to extend between the disc elements along the length of the serpentine device and are connected to the discs via an electroplate pad secured to the discs at a pre-determined location and configured in a pre-determined orientation. Thus, each Kapton interconnect, and therefore each disc 14, is electrically coupled to each immediately succeeding disc and each immediately preceding disc to create a serpentine device having segmented electrical capabilities along its length.

In another embodiment, interconnects 54 may comprise fluid transport tubes that function to carry fluid to the interconnected discs, as well as to any structures supported thereon designed to utilize the fluid transport tubes. In essence, it is contemplated herein that interconnects 54 may be modified to be the vehicle used to carry one or more types of transfer elements for the purpose of transferring electrical current, mechanical work, fluids, etc. to the various discs along all or only a portion of the length of the serpentine device 10, which transferred element is to be utilized at one or more disc sites.

The ability to segment the transfer elements extending between the disc elements making up the serpentine device allows each disc to function as an intelligent performance center independent of or in cooperation with any other disc, wherein each discs is able to perform the same or a different function than any other disc, depending upon the configuration of the discs and the transfer elements extending between the discs. As such, each of the discs may be multiplexed and/or networked together, as commonly understood.

Optionally formed in surface 18 of each of discs 14-a and 14-b are slots 124. Slots 124 function as another configuration for carrying transfer elements along the length of the serpentine device 10. As shown, the serpentine device 10 comprises four transfer elements extending between discs 14-a and 14-b and supported within slots 124. As mentioned, the transfer elements may comprise various types, and may be segmented or of a single, continuous or uninterrupted length. As shown, the types of transfer elements extending between discs 14-a and 14-b include an actuator tendon 128 carried in radial aperture 120 to control the bending of the serpentine device 10, an electrical conductive line 132 for transferring electrical current between discs 14, a fluid transport tube (shown generally as tubes 138), such as a fluid supply tube 140 and a fluid return tube 144 (negative pressure or vacuum tube). Each of the transfer elements in slots 124 are operably coupled to discs 14-a and 14-b via various connectors supported within slot 124. For example, tendon 128 is coupled via connector 160 as commonly known in the art. Fluid transport tubes 138 are coupled via fluid tube connectors 164. Electrical conductive lines 132 are connected via electrical connectors 168.

For each of the embodiments discussed above, the interconnects may function simply as transfer element carriers and may not comprise any load bearing capabilities. In these embodiments, the serpentine device will require a bendable member to link and interconnect each of the discs, as well as to provide bending and torsional strength to the serpentine device. Of course, the interconnects may function as both load bearing structures and as transfer element carriers, depending upon their particular material makeup and configuration. In the embodiments shown above, bendable member 110 comprises a coil configuration, wherein the coils comprise a circular cross-section. Other cross-sectional designs are also contemplated that may be utilized with the array of disc elements of the present invention.

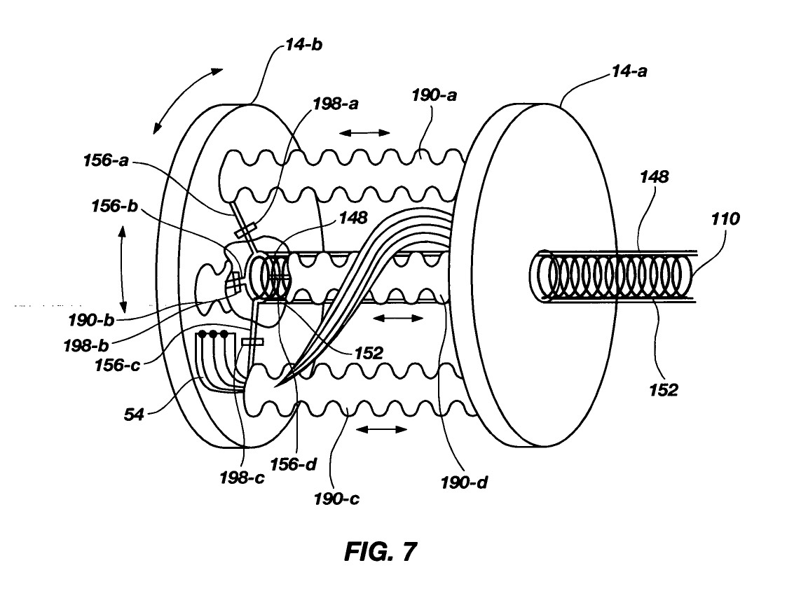

With reference to FIG. 7, illustrated is an exemplary actuation system used to actuate individual discs 14-a and 14-b, which are representative of the discs in the serpentine device. The actuation system is designed and configured to actuate individual discs within the serpentine device in a pre-determined direction in three-dimensional space. In this embodiment, the actuation system comprises a plurality of bladders, shown as bladders 190-a, 190-b, 190-c, and 190-d (referred to collectively as bladders 190). Bladders 190 are supported between the disc 14-a and 14-b and are configured to receive fluid therein for the purpose of actuating discs 14-a and 14-b. The bladders 190 may be configured to overcome any biasing forces applied by the interconnect 54, in the event it is so configured. Alternatively, if the interconnect 54 is not configured to provide a biasing support force (such as in the case with Kapton material), the bladders 190 will not be required to account for this. Supported about the bendable member 110 is a fluid supply 148 and a fluid return 152 configured to deliver and return fluid, respectively, from each of the bladders 190. The fluid supply 148 functions as a fluid bus, capable of providing fluid to each series of bladders on each disc in the serpentine device. Similarly, the fluid return 152 functions as a fluid bus, capable of draining fluid from each series of bladders on each disc.

Each of the bladders 190 is fluidly coupled to the fluid supply 148 and the fluid return 152 via delivery lines 156 (functioning to provide both supply and return), respectively, shown as delivery lines 156-a, 156-b, 156-c, and 156-d. In order to selectively control the inflation or deflation of the bladders 190, valves 198-a -198-d are supported about the surface of the discs. The specific operation of the valves will be apparent to one skilled in the art to selectively actuate one or more bladders individually or simultaneously. Other types of control mechanisms are contemplated and will also be apparent to one skilled in the art. In the embodiment shown, each bladder 190 comprises its own valve 198.

To actuate the discs 14-a and 14-b, one or more of the bladders 190 is inflated or filled with fluid. As one or more bladders is caused to inflate, this causes counter opposing forces to be exerted on each of the discs 14-a and 14-b, respectively, which ultimately functions to cause the discs to displace and pivot about a longitudinal axis of said serpentine device, which in this case is the bendable member 110. Each of the discs 14-a and 14-b are securely coupled to the bendable member so that any forces acting thereon will cause them to rotate about the bendable member 110. As the desired actuation is completed, the bladder(s) are deflated or drained, thus relieving the counter opposing forces and returning the discs to a static state about the bendable member 110.

In essence, fluids are routed up and down the bendable member to supply and return fluid, as needed. Alternatively, fluids may be routed and communicated to the bladders via fluid transport tubes, such as a fluid supply tube 140 and a fluid return tube 144 as illustrated in FIG. 6 and described above.

As will be recognized, the actuation of the bladders may be effectuated by hydraulic or pneumatic means.

In addition, other types of actuation systems or devices may be employed for selectively actuating the various discs for locomotion or other purposes. For example, and as stated herein, shape memory alloy material may be coupled between discs to perform the same actuation function as the described bladders. This is illustrated in FIG. 7 by shape memory alloy member 202. It is noted that more than one shape memory alloy member may be employed to achieve the desired actuation and locomotion.

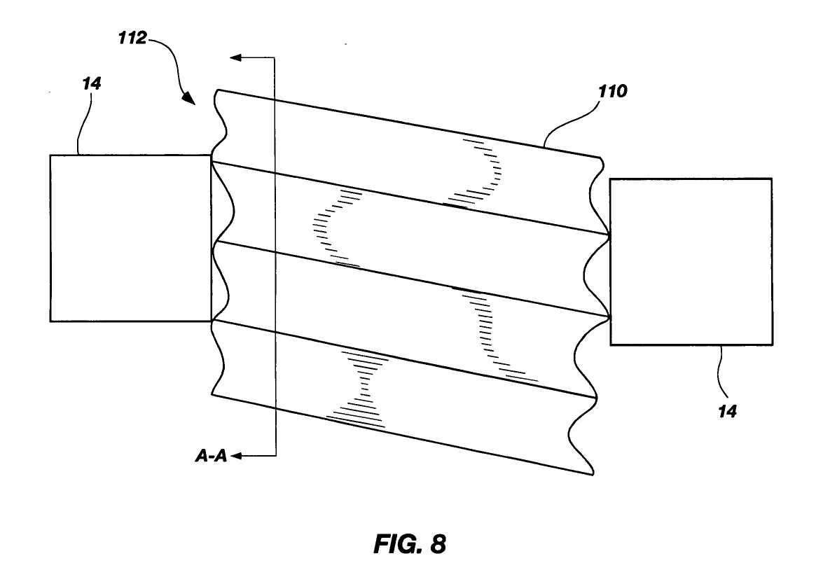

FIG. 8 illustrates a partial cutaway side view of one exemplary embodiment of a disc and bendable member. As shown, bendable member 110 comprises a non-circular cross-section. Specifically, bendable member 110 comprises a coiled member having a depression 112 formed therein configured to receive a disc 14 and to better accommodate the movement of the disc 14 about the bendable member 110 when the serpentine device 10 is in a bended state. The depression 112 may take on various design configurations and sizes, depending upon the application and size of the serpentine device. Essentially, the depression 112, or non-circular configuration of the bendable member 110, provides advanced or improved displacement or movement in that the discs are allowed to move and displace about the bendable member within the depression formed in the bendable member.

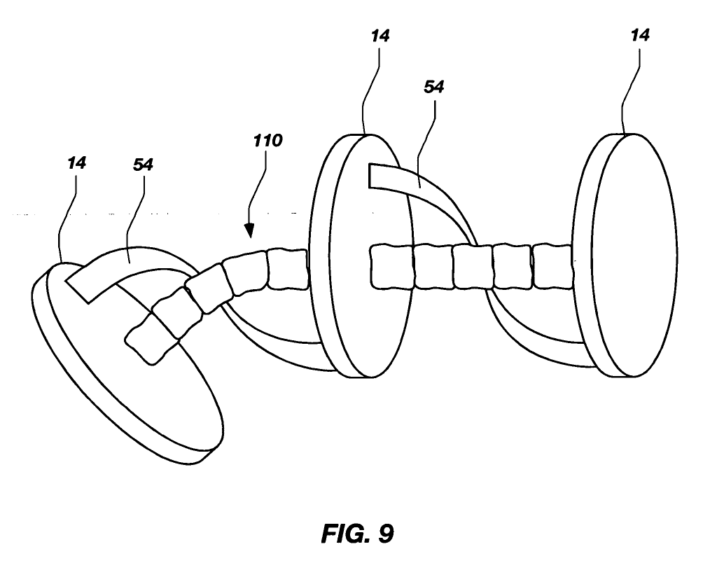

FIG. 9 illustrates another exemplary embodiment of a serpentine device 10 comprising a bendable member 110 in the form of a plurality of non-compressible segments coupled together via coupling means (not shown) and extending between the discs 14, wherein the bendable member 110 functions to provide additional compression and/or tensile support to the serpentine device 10 in addition to the interconnects 54. The bendable member 110 is designed to bend with the dynamic movements of the serpentine device 10, as well as to allow one or more discs or segments of discs to torque. As in other embodiments, the bendable member 110 functions to allow the serpentine device to be selectively pushed or pulled through a lumen, to maintain the spacing of the discs 14, and to provide added compression and tensile support to the serpentine device during its operation. Coupling means may comprise any structure, such as a tendon, that secures the segments together, while still allowing them to bend and flex as needed.

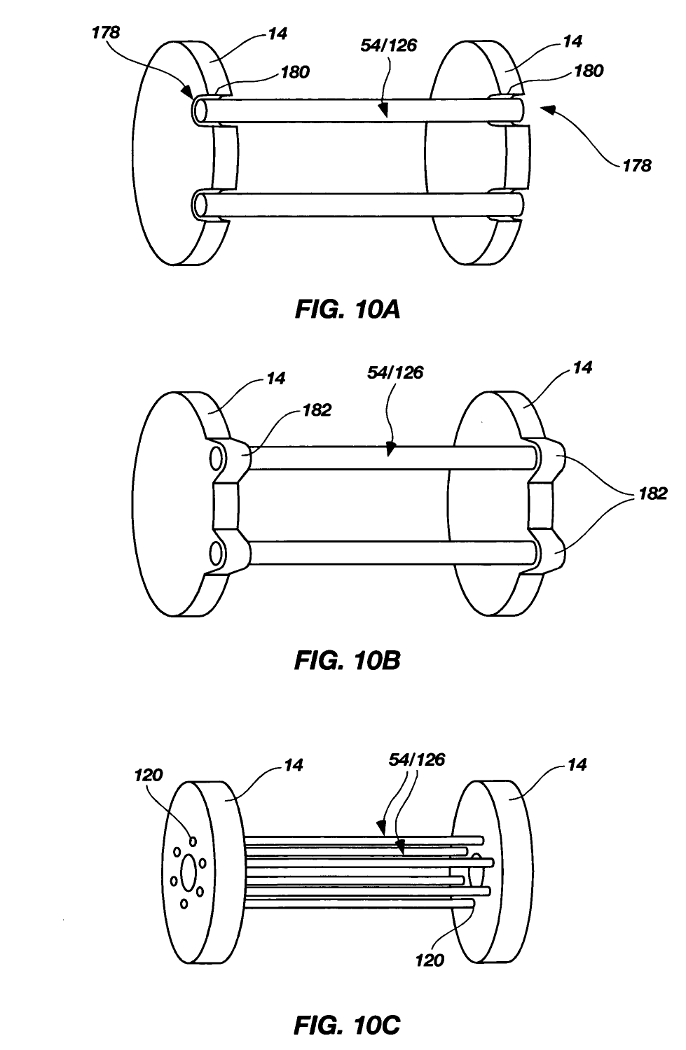

Referring now to FIGS. 10-A-10-C, shown are various exemplary embodiments of different ways to connect one or more transfer elements between the disc elements arrayed to form a serpentine device. FIG. 10-A illustrates discs 14 comprising two peripheral recesses 178 formed in the sidewall or edge of discs 14, which recesses are radially spaced a pre-determined length from one another at the periphery of discs 14. Discs 14 may comprise any number of peripheral recesses, including a plurality of peripheral recesses annularly spaced around the periphery of the discs 14. Peripheral recesses 178 are designed to carry or support therein a transfer element 126 therein, such as an electrical conductive line or a mechanical actuator (e.g., tendon), which transfer element may comprise a segmented or continuous transfer element. Peripheral recesses 178 may further be configured to support an interconnect 54 used to interconnect the discs 14 together. In addition, peripheral recesses 178 comprise one or more connection means 180 for connecting the transfer element 126 or interconnect 54, which type of connection means depends upon the type of transfer element or interconnect contained therein.

FIG. 10-B illustrates another exemplary embodiment, wherein discs 14 comprise two peripheral extensions 182 formed in the periphery of the discs and extending from the sidewall or edge of the discs 14, which peripheral extensions 182 are radially spaced a pre-determined distance from one another. Discs 14 may comprise any number of peripheral extensions, including a plurality of peripheral extensions annularly spaced around the periphery of the discs 14. Peripheral extensions 182 are also designed to carry or support segmented or continuous transfer elements 126 or interconnects 54. In addition, peripheral extensions 182 comprise various connection means for connecting the transfer elements 126 and/or interconnects 54.

FIG. 10-C illustrates still another exemplary embodiment, wherein discs 14 comprise a series of radially positioned or situated apertures 120 annularly spaced about a central or neutral axis at a position between the periphery of the discs and the neutral axis. Each of the radially positioned apertures are similar to the ones discussed above, namely in that they function to carry and support and operably connect a transfer element 126 and/or an interconnect.

In each of the embodiments just discussed for FIGS. 10-A-10-C, the transfer elements 126 or interconnects 54 extending between the discs 14 may be arranged in a parallel relationship with one another, or they may arranged to cross between discs. In addition, in each of the embodiments, discs 14 may further comprise a central aperture coaxial with the neutral axis of the serpentine device, wherein the central aperture is configured to receive a bendable member therethrough to provide compression and tension support to the discs 14 along the length of the serpentine device, as needed. In addition, each of the embodiments of the discs 14 shown in FIGS. 10-A-10-C may be designed so that the transfer elements carried therein may function as the interconnect for the discs, or they may be coupled with one or more interconnects, as discussed above.

The present invention segmented serpentine device may be utilized in any number of applications. One area well suited for the segmented serpentine device discussed herein is the medical field, wherein the serpentine device will comprise a guidewire to be used in various medical applications, namely various interventional medicine applications. For example, introducing a catheter directly through the complex arterial channels via a small external incision is generally not possible, owing to the relative rigidity and lack of steerability of the catheter alone. To ensure that the catheter gets to the correct site, a guidewire must first be introduced. The unique torquability, deformability, recovery and low whipping effect of the present invention will allow the surgeon to get a highly controllable serpentine device in place, as well as to perform various functions along the way, if so desired, as a result of the segmented capabilities of the present invention serpentine device. For example, a segmented serpentine device in the form of a guidewire, according to the present invention, may be used in conjunction with a camera, wherein the serpentine device supports one or more utility devices, such as a light source providing visible light to a local area, or a fluid disperser capable of squirting water to move blood out of the way while performing an operation. Or, the segmented serpentine device itself can be more complex. For example, the serpentine device may provide a miniature imaging device directly on the discs themselves, wherein the discs are also capable of performing a utilitarian, computer processing, or any other function.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited, except in the specification. Accordingly, the scope of the invention should be determined solely by the appended claims and their legal equivalents, rather than by the descriptions and examples given above.

What is claimed and desired to be secured by Letters Patent is:

1. A serpentine device having a proximal end and a distal end, said serpentine device comprising:
a series of discs arrayed in succession and on center along a common, neutral axis, said discs comprising a first and second surface; and
at least one flexible interconnect extending between and connecting each disc to any succeeding disc according to a pre-determined connection configuration to provide torsional and bending support for each of said discs under an applied load, said flexible interconnects biasing each of said discs to a pre-determined, static position, as well as allowing each of said interconnected discs to dynamically move through a pre-determined range of motions.

2. The serpentine device of claim 1, further comprising a bendable member extending coaxially about said neutral axis and operably coupled to said discs, said bendable member facilitating the axial alignment and positioning of each of said discs relative to one another when subject to various axial compression and tension forces, thus allowing said serpentine device to be selectively fed and retracted from a lumen.

3. The serpentine device of claim 2, wherein said bendable member is selected from the group consisting of a compression member, a coil spring and a ball joint.

4. The serpentine device of claim 2, wherein said bendable member comprises a non-circular cross section configured to facilitate improved displacement of said discs.

5. The serpentine device of claim 2, wherein said bendable member is segmented to allow selective removable attachment of said disc elements.

6. The serpentine device of claim 1, wherein said discs are equally spaced apart from one another to achieve uniform stiffness along said length.

7. The serpentine device of claim 1, wherein said discs are positioned at varying distances apart from one another to achieve stiffness segments of varying degree along said length.

8. The serpentine device of claim 1, wherein said discs are rigid.

9. The serpentine device of claim 1, wherein said discs comprise a planar configuration.

10. The serpentine device of claim 1, wherein said discs are formed of a piezoelectric material to create a local piezoelectric effect.

11. The serpentine device of claim 1, further comprising a plurality of transfer elements extending between said discs and configured to perform a designated transfer function.

12. The serpentine device of claim 11, wherein said transfer elements are axial transfer elements radially offset from said neutral axis.

13. The serpentine device of claim 11, wherein said transfer elements are supported on said interconnects.

14. The serpentine device of claim 11, wherein said transfer elements are received and supported within a slot extending radially outward from said neutral axis.

15. The serpentine device of claim 11, wherein said transfer elements are disposed annularly about a perimeter of said discs.

16. The serpentine device of claim 11, wherein said transfer elements are selected from the group consisting of a current conducting transfer element, an actuator tendon, a fluid supply tube, a light energy transfer element, an acoustical energy transfer element, a matter transfer element, and a mechanical energy transfer element.

17. The serpentine device of claim 11, wherein said transfer elements are segmented with each segment supported between any number of said discs, thus allowing said transfer elements to provide segmented operation of said serpentine device at any combination of said discs.

18. The serpentine device of claim 1, wherein said interconnects comprise flat, thin, flexible band elements having first and second surfaces, as well as first and second ends configured to couple to opposing surfaces of two successive discs, said band elements configured to maintain a constant strain across their length under various applied torsion and bending forces induced during actuation of said serpentine device.

19. The serpentine device of claim 18, wherein said pre-determined connection configuration comprises said first and second surfaces of said band elements arranged in a constant facing orientation between said successive discs.

20. The serpentine device of claim 18, wherein said pre-determined connection configuration comprises said first and second surfaces of said band elements inverted at least once.

21. The serpentine device of claim 18, wherein said pre-determined connection configuration comprises said first and second surfaces of said band elements inverted in a doubled over connection configuration.

22. The serpentine device of claim 18, wherein said first and second ends of said band elements are coupled to said surfaces of said discs in a radially outwardly extending orientation, as measured from said neutral axis.

23. The serpentine device of claim 18, wherein said band elements are comprised of a shape selected from the group consisting of a half-circle, semi-circular, an s-shape, linear, and any combination of these.

24. The serpentine device of claim 1, wherein said interconnects are formed of a shape memory material.

25. The serpentine device of claim 1, wherein said interconnects are formed of a spring element having an identified stiffness ratio.

26. The serpentine device of claim 25, wherein said spring element is coaxial with said neutral axis.

27. The serpentine device of claim 25, wherein said spring element is offset from said neutral axis.

28. The serpentine device of claim 1, wherein said interconnects are comprised of an electrical conducting material for transmitting an electrical signal between said discs as received from a power source.

30. The serpentine device of claim 1, wherein said interconnects comprise one or more electrical conductor materials integrally formed therewith for conducting an electrical signal between said discs as received from a power source.

31. The serpentine device of claim 1, wherein said interconnects are removably connected, thus allowing a selective number of said discs to be removed and a length of said serpentine device to be selectively altered.

32. The serpentine device of claim 1, wherein said discs comprise at least one peripheral and annual recess configured to operably support at least one transfer element.

33. The serpentine device of claim 1, wherein said discs comprise at least one peripheral extension configured to operably support at least one transfer element.

34. The serpentine device of claim 1, wherein said discs comprise a series of radial apertures spaced between a periphery of said discs and said neutral axis, each configured to operably support at least one transfer element.

35. The serpentine device of claim 1, further comprising a flexible sheath configured to contain said series of interconnected discs.

36. The serpentine device of claim 1, wherein said interconnected discs provide for a continuum of flexibility along an entire length of said serpentine device.

37. The serpentine device of claim 1, further comprising an actuation system configured to selectively actuate said discs in a pre-determined direction in three-dimensional space.

38. The serpentine device of claim 37, wherein the actuation system comprises a plurality of bladders supported between adjacent discs, each of said bladders being configured to apply a force to said discs, upon being actuated, to cause said discs to pivot about a longitudinal axis of said serpentine device.

39. The serpentine device of claim 38, wherein said bladders are each fluidly coupled to a fluid supply and a fluid return, said fluid supply and return communicating a fluid selected from hydraulic and pneumatic.

40. The serpentine device of claim 39, wherein said fluid supply and fluid return are each supported about a bendable member configured to support said discs.

41. The serpentine device of claim 39, wherein said fluid supply and fluid return are configured to function as a supply bus and a return bus, respectively, and wherein actuation of each of said bladders is controlled via valves fluidly coupled thereto and to said fluid supply and return.

42. The serpentine device of claim 37, wherein said actuation system is selected from the group consisting of a mechanical actuation system, a hydraulic actuation system, a pneumatic actuation system, shape memory alloy, and an electromechanical actuation system, each of which is configured to be supported about individual discs.

43. A serpentine device comprising:
a series of discs arrayed in succession and on center along a common, neutral axis, said discs comprising a first and second surface; and
at least one flexible interconnect extending from a sidewall of each disc to a sidewall of any succeeding disc according to a pre-determined connection configuration to provide torsional and bending support for each of said discs under an applied load, said flexible interconnects biasing each of said discs to a pre-determined, static position, as well as allowing each of said interconnected discs to dynamically move through a pre-determined range of motions.

44. The serpentine device of claim 43, wherein said interconnects wrap around said sidewalls of said discs to commence at a surface of one disc and terminate at a surface of a succeeding disc.

45. A serpentine device comprising:
a first disc arrayed on center along a neutral axis;
a second disc also arrayed on center along said neutral axis and having a pre-determined spacing from said first disc;
at least one interconnect removably connecting said first and second discs according to a pre-determined connection configuration to provide torsional and bending support for each of said discs under an applied load, said interconnects functioning to enable each of said interconnected discs to dynamically move through a pre-determined range of motions, said discs and said interconnects being configured to provide specific segmented movement and operation at said first and second discs; and
a bendable member supporting said discs, said bendable member facilitating the selective attachment of said discs, as well as the axial alignment, and positioning of each of said discs relative to one another when under axial compression and tension forces, thus allowing said serpentine device to be selectively controlled and operated in segments.

46. The serpentine device of claim 45, further comprising:
a plurality of discs arrayed in succession with said first and second discs and on center along a neutral axis; and
at least one interconnect connecting each of said plurality of discs, said interconnects providing segmented movement along an entire length of said serpentine device.

47. The serpentine device of claim 45, wherein said bendable member is comprised of a plurality of releasably coupled segments, thus contributing to the segmented capabilities of said serpentine device.

48. The serpentine device of claim 45, further comprising an actuation system configured to selectively actuate said first and second discs in a pre-determined direction in three-dimensional space.

49. The serpentine device of claim 48, wherein said actuation system is selected from the group consisting of a mechanical actuation system, a hydraulic actuation system, a pneumatic actuation system, shape memory alloy, and an electromechanical actuation system, each of which is configured to be supported about individual discs.

50. A serpentine device comprising multiple segments formed by a plurality of discs interconnected by at least one interconnect, said multiple segments potentially exhibiting different bending, stiffness, and torsional performance characteristics.

51. A method for assembling a serpentine device comprising:
a) obtaining a plurality of disc elements;
b) arranging said disc elements along a neutral axis; and
c) connecting each of said disc elements to at least one adjacent disc with at least one interconnect according to a pre-determined connection configuration to provide specific segmented movement and operation at said discs, said interconnects functioning to allow each of said interconnected discs to dynamically move through a pre-determined range of motions.

52. The method of claim 51, further comprising axially supporting each of said discs with a bendable member.

53. The method of claim 52, further comprising operably connecting a transfer element to said discs, said transfer element configured to perform a designated transfer function.

54. The method of claim 53, further comprising segmenting said bendable member, said transfer element, and said interconnects to selectively alter the length of and to allow segmented operation of said serpentine device.

55. The method of claim 43, wherein said connecting comprises inverting said interconnects.

56. The method of claim 43, further comprising actuating said discs to selectively cause said discs to pivot in a pre-determined direction in three-dimensional space.
